(19) United States
(12) Patent Application Publication
(10) Pub. No.: US 2009/0180003 A1
(43) Pub. Date: Jul. 16, 2009

(54) Digital photographing apparatus and method of controlling the same

(75) Inventor: Deok-eun Cho, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/283,901

(22) Filed: Sep. 15, 2008

(30) Foreign Application Priority Data
Jan. 11, 2008 (KR) 10-2008-0003468

(51) Int. Cl. H04N 5/76

(52) U.S. Cl. 348/231.2; 348/E05.031

(57) ABSTRACT

A digital photographing apparatus is provided that determines a file name of an image file according to a Design rule for Camera File (DCF) standard, and a method of controlling the same. According to the digital photographing apparatus and the method of controlling the same, a user defined file name as determined by a user can be used.

### CROSS-REFERENCE TO RELATED PATENT APPLICATIONS

This application claims the benefit of Korean Patent Application No. 10-2008-0003468, filed on Jan. 11, 2008, in the Korean Intellectual Property Office, the disclosure of which is incorporated herein in its entirety by reference.

### BACKGROUND

1. Field of the Invention

The present invention relates to a digital photographing apparatus which photographs a subject to generate image data and generates an image file including the image data, a name of the image file being generated according to a Design rule for Camera File (DCF) standard, and a method of controlling the digital photographing apparatus.

2. Description of the Related Art

In general, a predetermined file name is provided in an image format, such as JPG or TIF, to images photographed using digital cameras and the images to which the file names are provided are stored. Most digital cameras currently introduced provide a predetermined file name to photographed images according to a Design rule for Camera File (DCF) standard, and store the images. The DCF standard is a standardized file format by the Japan Electronics and Information Technology industries Association (JEITA) as a method of storing data in digital cameras, and using the digital cameras. The advantages of the DCF file format are that images photographed with digital cameras that comply with the DCF file format can be reproduced in other digital cameras.

According to the DCF standard, a naming rule for determining directories and file names exists. More specifically, the directory names (‘100ABCDE’, 102ABCDE’, . . . ) include a number part formed of three numbers and a letter part formed of five letters. In the number part, the numbers from ‘100’ to ‘999’ can be used and in the letter part, ‘A’-‘Z’, ‘0’-‘9’ and ‘_’ can be used. The letter part is generally provided according to a manufacturer or a model of a product. The number part is provided by sequentially increasing the number by 1 according to the order of directories generated.

Moreover, according to the DCF standard, the file name includes eight letters. Also, the file name is formed of a letter part including four letters, a number part including four numbers, and a file extension. The letter part is formed of capital alphabet letters and the number part is formed of the numbers between “0001” and “9999.” Files located in the same directory cannot use the same file names and the letter part is provided according to a manufacturer or a model of a product, as similarly to the directory name. The number part is provided by sequentially increasing the number by 1 according to the order of the files generated.

According to the DCF standard, directories and file names are generated as follows.

When photographed images are to be recorded, whether a DCF image route directory exists is searched for first. According to the searching result, if a DCIM image route directory does not exist, the DCF image route directory is generated, a lower DCF directory is generated according to the DCF standard, a predetermined file name is provided to the lower DCF directory, and a DCF file is stored.

As such, images photographed using a conventional digital camera device are stored in a predetermined memory unit of the conventional digital camera device with a meaningless file name such as ‘SA500001’, ‘SA500002’, ‘SA500003’, etc. Thus, it is difficult for a user to later identify when and where the images were photographed by referring only to such meaningless file names as above.

That is, in the conventional digital camera device, when there are images that were photographed a long time ago or a large number of images photographed, it is inconvenient to search for a desired image due to the fact that its file name is allocated in accordance with the naming rule of the DFC standard. Accordingly, after the images are firstly checked, information in the images, for example, photograph locations, can be identified.

In addition, when files of images photographed using digital cameras are transferred to PCs, a user has to change the file names with separate file names for convenience of future searching, thereby experiencing inconvenience.

### SUMMARY

The present invention provides a digital photographing apparatus in which a user defined file name can be used as a name of an image file for convenience of searching for the image file.

According to an aspect of the present invention, there is provided a method of controlling a digital photographing apparatus, the method including: inputting a first user defined file name; photographing a subject and generating a first image data; generating a first mapping data corresponding to the first user defined file name; and generating a first image file including the first mapping data and the first image data, wherein the first image file has a file name according to a Design rule for Camera File (DCF) standard.

The method may further include: inputting a second user defined file name; photographing a subject and generating a second image data; generating a second mapping data corresponding to the second user defined file name; and generating a second image file including the second mapping data and the second image data, wherein the first image file has a file name according to the DCF standard.

The method may further include: selecting the first image file; reading the first user defined file name according to the first mapping data; and displaying the first user defined file name. In displaying the first user defined file name, the first image data may be displayed with the first user defined file name. In addition, the first user defined file name may be displayed on a display unit of an external device, when the digital photographing apparatus is connected to the external device, and a file name according to the DCF standard may be displayed on a display unit of an external device, when the digital photographing apparatus is not connected to the external device.

The method may further include: generating a first folder; and generating first mapping information indicating the relationship between the first user defined file name and the first folder. The first image file may be stored to the first folder.

The method may further include: photographing a subject and generating second image data; and generating a second image file including the first mapping data and the second image data, wherein the second image file has a file name according to the DCF standard.

The method may further include: inputting a second user defined file name; generating the second mapping information indicating the relationship between the second user defined file name and the first folder; photographing a subject and generating the second image data; generating the second mapping data corresponding to the second user defined file name; and generating a second image file including the second mapping data and the second image data, wherein the second image file has a file name according to the DCF standard.

According to another aspect of the present invention, there is provided a digital photographing apparatus including: an operation unit to input a user defined file name; an imaging unit to photograph a subject and generate an image data; a mapping data generation unit which generates a mapping data corresponding to the user defined file name; and a memory unit including the mapping data and the image data so as to generate an image file having a file name according to the DCF standard.

The memory unit may store the user defined file name.

The apparatus may further include a folder generation unit which generates a folder; and a mapping information generation unit which generates mapping information indicating the relationship between the folder and the user defined file name, wherein the memory unit may store the folder and the mapping information.

The apparatus may further include an auxiliary memory unit which stores the image file.

The apparatus may further include a display unit which displays the user defined file name read from the mapping data.

The apparatus may further include a communication unit which is connectable to an external device; and a connection sensing unit which determines whether the external device is connected to the communication unit, wherein when the external device is connected to the communication unit as based on the determination result of the connection sensing unit, the user defined file name is displayed on a display unit of the external device, and when the external device is not connected to the communication unit, a file name according to the DCF standard may be displayed on the display unit of the digital photographing apparatus.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a digital photographing apparatus according to an embodiment of the present invention;

FIG. 2 is a flowchart illustrating a method of generating an image file, as part of a method of controlling a digital photographing apparatus, according to an embodiment of the present invention;

FIG. 3 is a diagram of an image file generated using the method of FIG. 2;

FIG. 4 is a flowchart illustrating a method of reproducing an image file generated using the method of FIG. 2, as part of the method of controlling a digital photographing apparatus, according to an embodiment of the present invention;

FIGS. 5A, B are diagrams illustrating an image file reproduced using the method of FIG. 4;

FIG. 6 is a flowchart illustrating a method of controlling a digital photographing apparatus, according to an embodiment of the present invention, the method including inputting a user defined file name, generating a folder, and generating a plurality of image files;

FIGS. 7A, B are diagrams illustrating generating of an image file including mapping data, and mapping information, as performed in the method of FIG. 6;

FIG. 8 is a flowchart illustrating a method of controlling a digital photographing apparatus, according to another embodiment of the present invention, the method including inputting a plurality of user defined file names, generating a folder, and generating a plurality of image files;

FIG. 9 is a diagram illustrating recording of an image file including mapping data, and mapping information, as performed in the method of FIG. 8;

FIG. 10 is a flowchart illustrating a method of controlling a digital photographing apparatus, according to another embodiment of the present invention, the method including inputting a plurality of user defined file names, generating a plurality of folders, and generating a plurality of image files;

FIGS. 11A, B are diagrams illustrating recording of image files including mapping data, mapping information, and a folder, as performed in the method of FIG. 10;

FIG. 12 is a diagram illustrating changing of a user defined file name of an image file as performed in a method of controlling a digital photographing apparatus, according to an embodiment of the present invention; and

FIGS. 13A, B are diagrams illustrating file names displayed on a display unit of a digital photographing apparatus, according to an embodiment of the present invention, or on an external device in the case when the external device is connected to the digital photographing apparatus, respectively, in a method of controlling the digital photographing apparatus according to an embodiment of the present invention.

### DETAILED DESCRIPTION OF THE PREFERRED EMBODIMENTS

Hereinafter, the present invention will be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Also, the terms used herein are defined according to the functions of the present invention. Thus, the terms may vary depending on users or operators and usages. That is, the terms used herein must be understood based on the descriptions made herein.

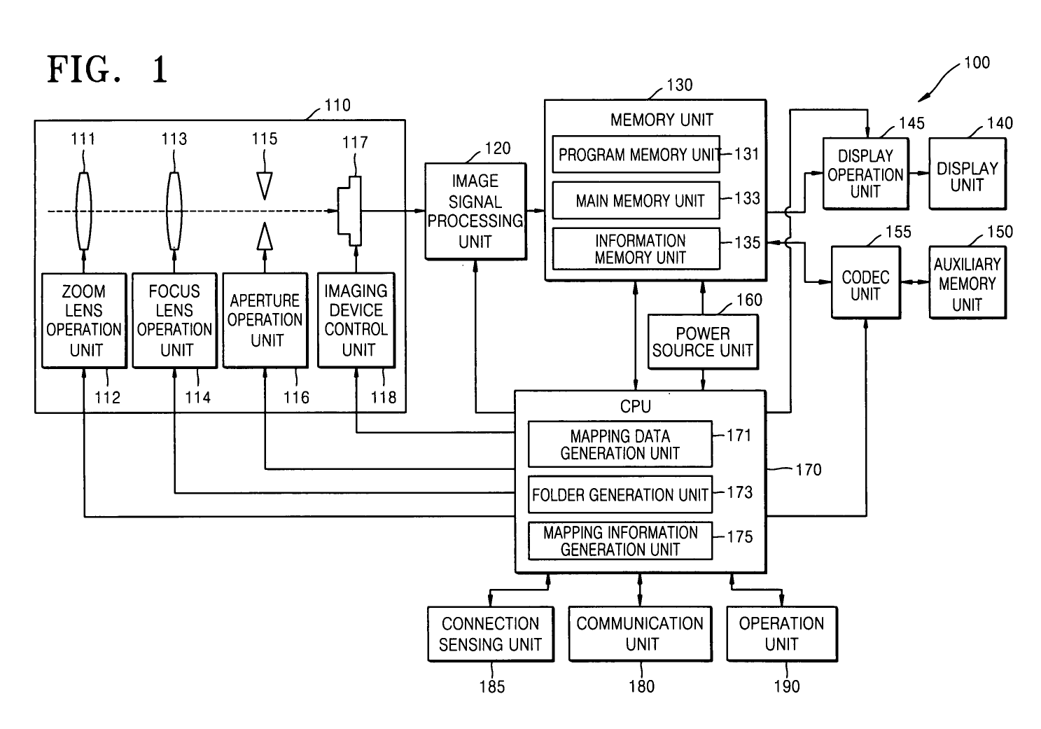

FIG. 1 is a block diagram of a digital photographing apparatus 100 according to an embodiment of the present invention.

Referring to FIG. 1, the digital photographing apparatus 100 includes an imaging unit 110, an image signal processing unit 120, a memory unit 130, a display unit 140, an auxiliary memory unit 150, a power source unit 160, a central processing unit (CPU) 170, a communication unit 180, and an operation unit 190.

The imaging unit 110 includes a zoom lens 111, a focus lens 113, an aperture 115, and an imaging device 117, wherein the zoom lens 111 continuously changes the size of a subject image, the focus lens 113 adjusts a focus, and the aperture 115 controls a light quantity.

The imaging unit 110 generates image data that corresponds to a subject. More specifically, when a photographing signal (a release signal) is input by the operation unit 190, light passing through the zoom lens 111, the focus lens 113, and the aperture 115 is received by the imaging device 117 on which a two-dimensional image corresponding to the subject is formed, thereby generating image data. The imaging device 117 includes a Charge Coupled Device (CCD) or a Complementary Metal Oxide Semiconductor Image Sensor (CIS), which convert an optical signal into an electrical signal.

The locations of the zoom lens 111 and the focus lens 113 included in the imaging unit 110 are respectively controlled by a zoom lens operation unit 112 and a focus lens operation unit 113 and the opening of the aperture 115 is controlled by an aperture operation unit 116. In addition, the sensitivity of the imaging device 117 is controlled by an imaging device control unit 118. The zoom lens operation unit 112, the focus lens operation unit 114, the aperture operation unit 116, and the imaging device control unit 118 each receive a control signal from the CPU 170 according to a result calculated in the CPU 170 based on exposure information and focus information.

A predetermined signal processing is performed by the image signal processing unit 120 on an electrical signal generated from the imaging device 117. More specifically, the image signal processing unit 120 converts an analog signal into a digital signal, improves image quality by performing signal processing such as auto white balance, auto exposure, and gamma correction, in order to convert image data that is visually suitable, and outputs an image signal having improved image quality. Moreover, the image signal processing unit 120 performs image processing such as color filter array interpolation, color matrix, color correction, and color enhancement.

The image data according to an embodiment of the present invention includes not only analog image data output from the imaging unit 110 but also digital image data and image data on which a predetermined image processing can be performed.

The image data on which an optimum signal processing is performed by the image signal processing unit 120 to record or display the image data on the digital photographing apparatus 100 is temporarily stored in the memory unit 130.

The memory unit 130 includes a program memory unit 131, a main memory unit 133, and an information memory unit 135, wherein the program memory unit 131 stores a program related to the operation of the digital photographing apparatus 100 regardless of whether a power source is being applied to the digital photographing apparatus 100, and the main memory unit 133 temporarily stores image data and other data while a power source is being applied to the digital photographing apparatus 100, thereby generating an image file, and the information memory unit 135 stores and maintains predetermined information.

The program memory unit 131 stores a program and other application programs for operating the digital photographing apparatus 100. The CPU 170 controls each element of the digital photographing apparatus 100 according to programs stored in the program memory unit 131.

The main memory unit 133 temporarily stores image data output from the image signal processing unit 120 or the auxiliary memory unit 150, and combines mapping data corresponding to a user defined file name with the temporarily stored image data, thereby generating an image file. The image file includes mapping data to be capable of reading a user defined file name previously stored and a file name of the image file generated from the main memory unit 133 such that the file name complies with the DCF standard.

The information memory unit 135 may store a user defined file name. Moreover, when the information memory unit 135 generates a folder, which is an upper group storing an image file according to the DCF standard, mapping information indicating the relationship between the folder and the user defined file name may be stored in the information memory unit 135.

A power source of the power source unit 160 is applied to the main memory unit 133 to operate the digital photographing apparatus 100 and the power source unit 160 may be directly connected to the main memory unit 133. Accordingly, the main memory unit 133 may copy code previously stored in the program memory unit 131 to the main memory unit 133 and convert the code into executable code to rapidly boot the digital photographing apparatus 100. In addition, a predetermined power source, apart from the power source applied to operate the digital photographing apparatus 100, may be applied to the main memory unit 133 to rapidly read previously stored image data after re-booting, even if a power source of the digital photographing apparatus 100 is turned off.

The image file temporarily stored in the memory unit 130 may be displayed on the display unit 140 via a display operation unit 145. The display unit 140 displays an image corresponding to the subject as a preview function, in order to recognize the subject being photographed in a photographing mode, and displays image data photographed in a playback mode. The display operation unit 145 converts a signal suitable for displaying an image to the display unit 140 and applies the signal to the display unit 140. The display unit 140 may be various display devices such as a liquid crystal display (LCD) device, an organic light emitting diode (OLED), and an electrophoresis display device (EDD).

The digital photographing apparatus 100 includes the auxiliary memory unit 150 that stores an image file including mapping data and image data. In addition, the auxiliary memory unit 150 may further include mapping information indicating the relationship between a folder and a user defined file name.

The auxiliary memory unit 150 may be a fixed-type semiconductor memory such as external flash memory, a card type or stick type removable semiconductor memory such as card type flash memory, and a magnetic memory medium such as a hard disk or a floppy disk.

The digital photographing apparatus 100 includes a codec unit 155 that compresses or releases for storing data to the auxiliary memory unit 150 or reading stored data from the auxiliary memory unit 150, respectively.

The power source unit 160 supplies a predetermined power source for operating the digital photographing apparatus 100. Moreover, the power source unit 160 is connected to the memory unit 130, specifically, to the main memory unit 133 so as to supply a predetermined power source thereto, apart from the power source for operating the digital photographing apparatus 100, thereby maintaining or initializing data stored in the main memory unit 133. The power source unit 160 may be a battery such as internal type lithium ion battery and/or interface connected to an external power source.

The CPU 170 controls the entire operation of the digital photographing apparatus 100. The CPU 170 processes data according to an operation system and application programs stored in the program memory unit 131 and controls each element of the digital photographing apparatus 100. Also, the CPU 170 performs a predetermined operation according to the operation system, temporarily stores the operation result, and controls each element of the digital photographing apparatus 100 according to the operation result.

In particular, the CPU 170 of the digital photographing apparatus 100 according to the current embodiment of the present invention includes a mapping data generation unit 171 to generate simple mapping data corresponding to a user defined file name such that the generated simple mapping data is temporarily stored in the main memory unit 133 that may thus generate an image file including the mapping data and the image data.

The CPU 170 includes a folder generation unit 173 which generates a folder that is an upper directory storing the image file to the auxiliary memory unit 150 or the memory unit 130, according to the DCF standard. Also, the CPU 170 includes a mapping information generation unit 175 which generates mapping information indicating the relationship between the folder generated by the folder generation unit 173 and a user defined file name. The mapping information generated by the mapping information generation unit 175 may be stored in the information memory unit 135.

The digital photographing apparatus 100 includes the communication unit 180 which is connectable to an external storage medium or an external display device so as to transmit the image file. When an external device is connected to the communication unit 180, the file name of the image file or image data may be displayed on a display unit of the external device.

The digital photographing apparatus 100 may further include a connection sensing unit 185 which senses whether an external device is connected to the communication unit 180. When the connection sensing unit 185 senses that the communication unit 180 is connected to an external device, a user defined file name may be displayed on a display unit of the external device. When the connection sensing unit 185 senses that the communication unit 180 is not connected to an external device, a file name according to the DCF standard may be displayed on the display unit 140 of the digital photographing apparatus 100 according to the current embodiment of the present invention.

The operation unit 190 includes buttons for a user to operate or to set up the digital photographing apparatus 100. In the present invention, a user may input a desired file name through the operation unit 190. For example, the operation unit 190 may include a power source button for supplying a power source so as to operate the digital photographing apparatus 100, a release button for photographing a subject, and a function button for selecting a photographing mode or reproducing mode and for setting up effect parameters. The operation unit 190 is not limited to these buttons and thus may be a touch screen, a touch pad, or a remote controller.

As described above, the digital photographing apparatus 100 may be used to input and store user desired file names, generate photographed image data and mapping data corresponding to a user defined file name, and generate an image file including the image data and the mapping data. In addition, the user defined file name can be displayed in the digital photographing apparatus 100 using the mapping data. Accordingly, the image file can be easily searched for and identified through the user defined file name.

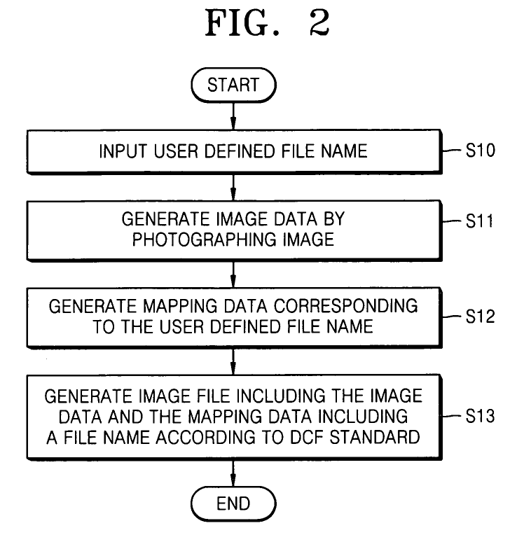

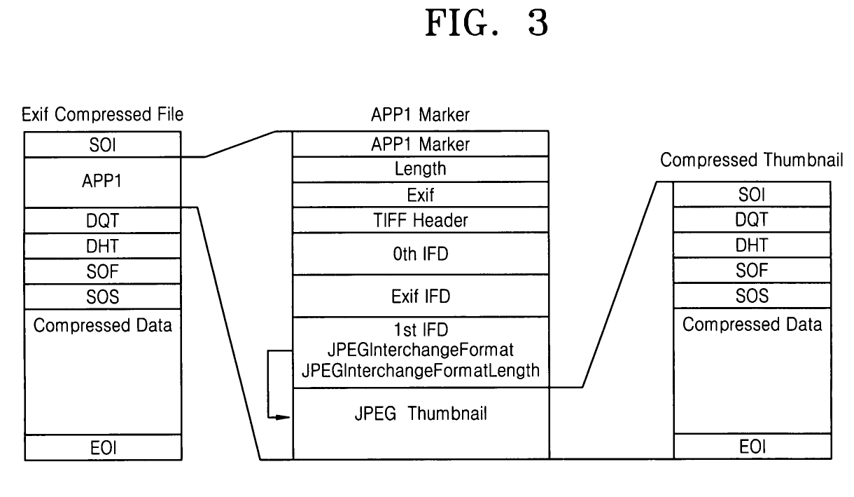

FIG. 2 is a flowchart illustrating a method of generating an image file, as part of a method of controlling a digital photographing apparatus, according to an embodiment of the present invention. FIG. 3 is a diagram of an image file generated using the method of FIG. 2.

Referring to FIG. 2, in the method of controlling the digital photographing apparatus, a user defined file name is firstly input in operation 10. The input user defined file name is stored in memory. Then, an image is photographed and image data is generated in operation 11. Mapping data corresponding to the user defined file name is generated in operation 12 and an image file including the image data and the mapping data is generated in operation 13. Here, the image file may have a file name which complies with the DCF standard.

The mapping data may be generated during the inputting or storing of the user defined file name. More preferably, since the mapping data should be stored to a header portion of the image file, the mapping data may be generated as a simple symbol so as to decrease the capacity of the mapping data.

Storing of the mapping data to the image file is described in more detail with reference to FIG. 3. FIG. 3 illustrates an Exchangeable image file format (EXIF) and abbreviations shown in FIG. 3 are as listed below. The mapping data is included in a header portion of the EXIF, and the APP1. The APP1 includes an APP1 marker, an EXIF identification code, the size of the APP1, and a TIFF Header. The size of the APP1 does not exceed 64 kbyte in a JPEG image file. Accordingly, relatively simple mapping data corresponding to the user defined file name may be stored in the APP1.

The mapping data may be included, more specifically, in a tag relating to user information of the TIFF Header. The tag may record user desired information and store mapping data corresponding to the user defined file name input by the user.

| | |
|---|---|
| SOI: | Start of image |
| APP1: | Application marker segment 1 |
| DQT: | Quantization marker segment 1 |
| DHT: | Huffman table |
| SOF: | Frame header |
| SOS: | Scan header |
| EOI: | End of image |
| IFD: | Image file directory |
| TIFF: | Tagged image file format |

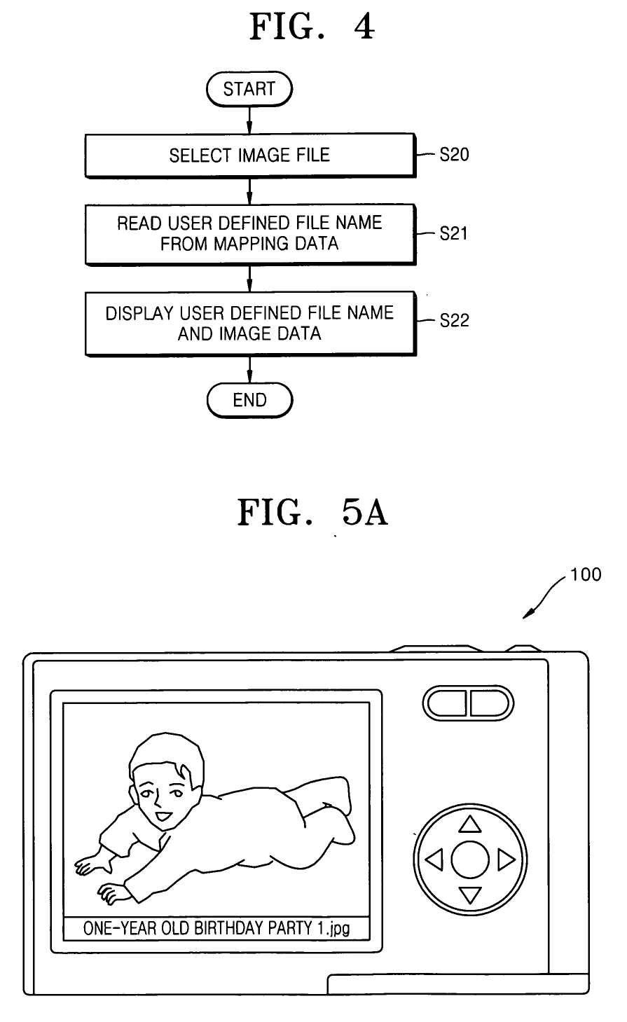

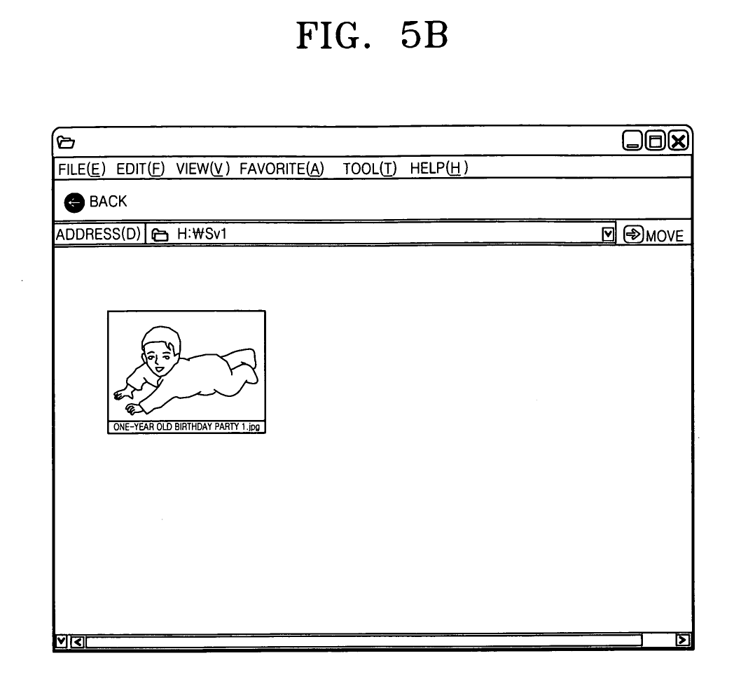

FIG. 4 is a flowchart illustrating a method of reproducing the image file generated using the method of FIG. 2, as part of the method of controlling a digital photographing apparatus, according to an embodiment of the present invention. FIGS. 5A and 5B are diagrams illustrating the image file reproduced using the method of FIG. 4.

Referring to FIG. 4, the image file including the image data and the mapping data is selected in operation 20. Then, the user defined file name is read from the mapping data of the image file in operation 21. Here, the user defined file name is previously stored in a memory unit included in the digital photographing apparatus or in an auxiliary memory unit that is removable from the digital photographing apparatus so that the corresponding user define file name may be read from the memory unit or the auxiliary memory unit using the mapping data. The read user defined file name and the image data from the image file are displayed in operation 22.

FIG. 5A illustrates image data displayed on the display unit 140 disposed at rear side of the digital photographing apparatus 100 and its corresponding user defined file name. The image data and its corresponding user defined file name, “one-year-old birthday party 1.jpg” are displayed on the display unit 140.

FIG. 5B illustrates that the image data and its corresponding user defined file name are displayed on an external display device connected to the digital photographing apparatus 100. More specifically, when the digital photographing apparatus 100 is connected to an external device through the communication unit 180 or the auxiliary memory unit 150 that is removable from the digital photographing apparatus 100 is connected to an external device, the image file and a folder including the image file received from the digital photographing apparatus 100 or the auxiliary memory unit 150 are displayed on a window of the external device. Here, the user defined file name of the image file, “one-year old birthday party 1.jpg” is displayed and a thumbnail image of the image data is displayed as an icon.

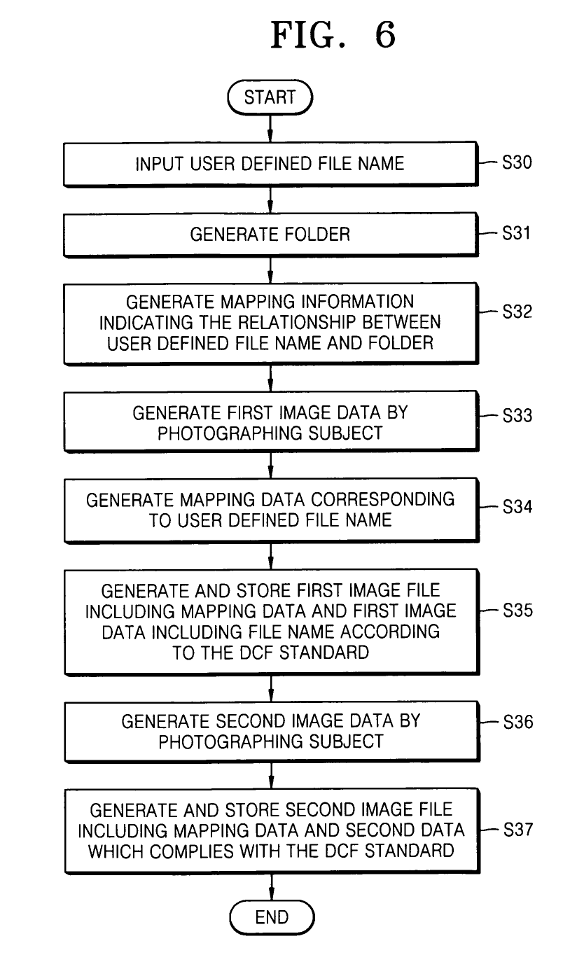

FIG. 6 is a flowchart illustrating a method of controlling a digital photographing apparatus, according to an embodiment of the present invention, when a user defined file name is input, a folder corresponding to the user defined file name is generated, a plurality of image files generated later are stored in the folder, and the plurality of image files have mapping data corresponding to the user defined file name. In the current embodiment, the method of controlling the digital photographing apparatus, when a user defined file name is input, a folder is generated, and a plurality of image files are generated, is described.

More specifically, referring to FIG. 6, the user defined file name is input in operation 30. Then, the folder is generated in operation 31. The folder may be automatically generated or arbitrarily generated by the user according to the input of the user defined file name. In addition, the folder may be generated to the auxiliary memory unit, which stores the image file.

When the folder is generated, mapping information indicating the relationship between the user defined file name and the folder is generated in operation 32. The mapping information may be stored in an information memory unit that is an internal memory of the digital photographing apparatus. However, the present invention is not limited thereto and the mapping information may be stored in the auxiliary memory unit, and more likely to the folder.

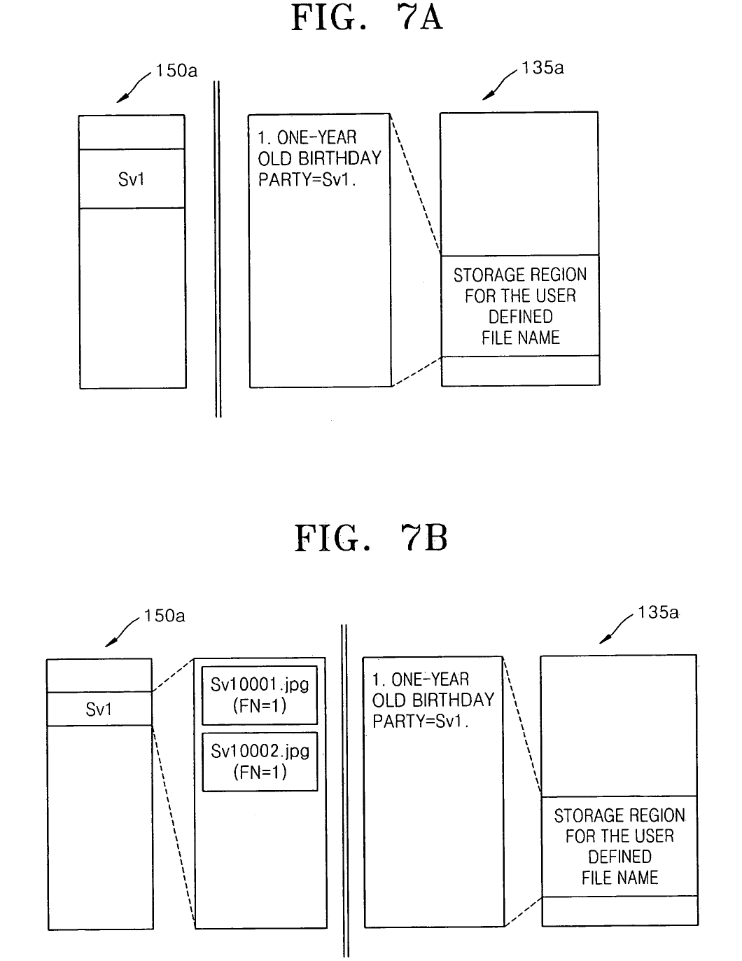

Referring to FIG. 7A, a folder Sv1 is generated in the auxiliary memory unit 150a of the digital photographing apparatus 100 of FIG. 1 and the mapping information “1. one-year old birthday party=Sv1” is stored in a storage region, for the user defined file name, from among a plurality of partitioned blocks in the information memory unit 135a. The subject is photographed and a first image data is generated in operation 33.

The mapping data corresponding to the user defined file name is generated in operation 34. The mapping data may be generated when the user defined file name is input, before the first image data is generated. Then, a first image file including the mapping data and the first image data that has a file name according to the DCF standard is generated in operation 35. Then, the first image file is stored in the folder Sv1.

Next, a second image data is generated by photographing a second image in operation 36. A second image file including the generated second image data and the mapping data that complies with the DCF standard is generated in operation 37, and the second image file is also stored in the folder Sv1.

FIG. 7B illustrates that the first image file and the second image file are stored in the folder Sv1. More specifically, the folder Sv1 is generated in the auxiliary memory unit 150a of the digital photographing apparatus 100 of FIG. 1 and two image files are stored in the folder Sv1.

The first image file has the file name according to the DCF standard, “Sv10001.jpg” and the second image file has the file name according to the DCF standard, “Sv10002.jpg.” Also, the first and second image files have the same mapping data “FN=1” that is related to the mapping information “1. one-year old birthday party=Sv1” indicating the relationship between the user defined file name, “one-year old birthday party” and the folder Sv1. That is, the mapping information that is firstly recorded is extracted from the mapping data “FN=1” from among the storage region for the user defined file name included in the information memory unit 135a and the user defined file name “one-year old birthday party” stored in the mapping information may be read.

Accordingly, in the first image file and the second image file, the file names determined according to the DCF standard which are respectively “Sv10001.jpg” and “Sv10002.jpg” may be converted into “one-year old birthday party1.jpg” and one-year old birthday party2.jpg” by using the mapping data “FN=1.”

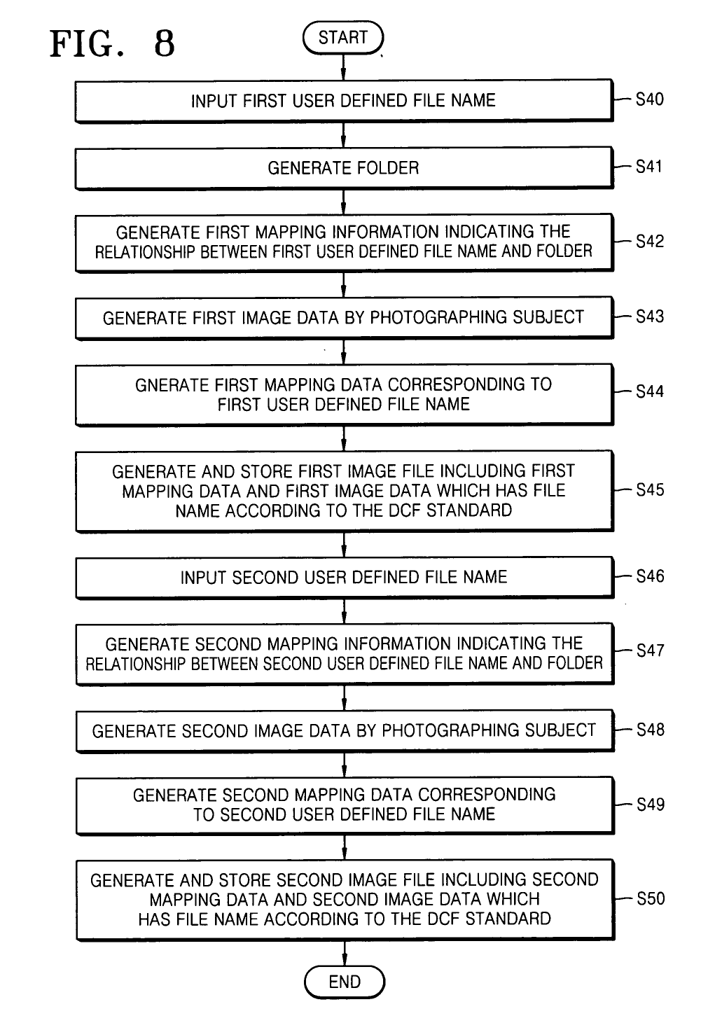

FIG. 8 is a flowchart illustrating a method of controlling a digital photographing apparatus, according to another embodiment of the present invention, the method including inputting a plurality of user defined file names, generating a folder, and generating a plurality of image files. In the current embodiment, the method includes generating a folder, a plurality of user defined file names, and a plurality of image files.

Referring to FIG. 8, a first user defined file name is input in operation 40. Then, a folder is generated in operation 41, and a first mapping information indicating the relationship between the first user defined file name and the folder is generated in operation 42. A subject is photographed and a first image data is generated in operation 43.

A first mapping data corresponding to the first user defined file name is generated in operation 44. The first mapping data may be generated before photographing the subject in operation 43.

Then, a first image file including the first image data and the first mapping data, and the first image file has a file name according to the DCF standard is generated in operation 45. The first image file is stored in the folder. Next, a second user defined file name that is different from the first user defined file name is input in operation 46. When the first user defined file name is determined as “one-year old birthday party”, the second user defined file name may be “wedding ceremony”.

Here, the folder that is same as the folder storing the first image file is used and thus another folder is not generated. Accordingly, a second mapping information indicating the relationship between the input second user defined file name and the folder is generated in operation 47.

A second image data is generated by photographing a subject in operation 48. A second mapping data corresponding to the second user defined file name is generated in operation 49. The second mapping data indicates the second mapping information and may be generated as simple data to be inserted into a header portion of an image file. Then, a second image file including the second image data and the second mapping data including a file name according to the DCF standard is generated and the generated second image file is stored in the folder, in operation 50.

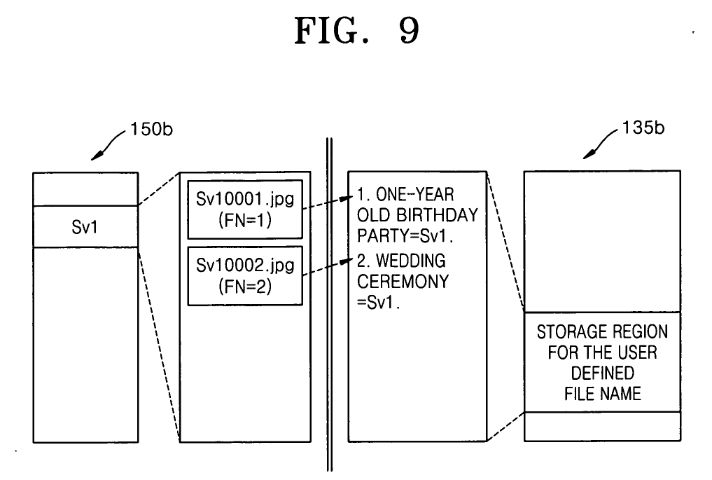

For example, referring to FIG. 9, the folder Sv1 is generated in a region of the auxiliary memory unit 150b included in the digital photographing apparatus 100 of FIG. 1 and two image files are stored in the folder Sv1. That is, one is the first image file having the file name, “Sv10001.jpg”, according to the DCF standard and the mapping data, “FN=1l”, and the other one is the second image file having the file name, “Sv10002.jpg”, according to the DCF standard and the mapping data, “FN=2”.

Also, mapping information indicating the relationship between the folder and the user defined file name is recorded to a storage region in the information memory unit 135, which is an internal memory unit of the digital photographing apparatus 100 illustrated in FIG. 1. Two types of mapping information are recorded, that is, one is a first mapping information, “1 one-year old birthday party=Sv1”, and the other one is a second mapping information, “2.wedding ceremony=Sv1.”

The first mapping data, “FN=1”, indicates the first mapping information, “1 one-year old birthday party=Sv1”, and the second mapping data, “FN=2”, indicates the second mapping information, “2.wedding ceremony=Sv1.” Accordingly, the first user defined file name, “one-year old birthday party”, may be read from the first mapping data included in the first image file and the second user defined file name, “wedding ceremony” may be read from the second mapping data included in the second image file.

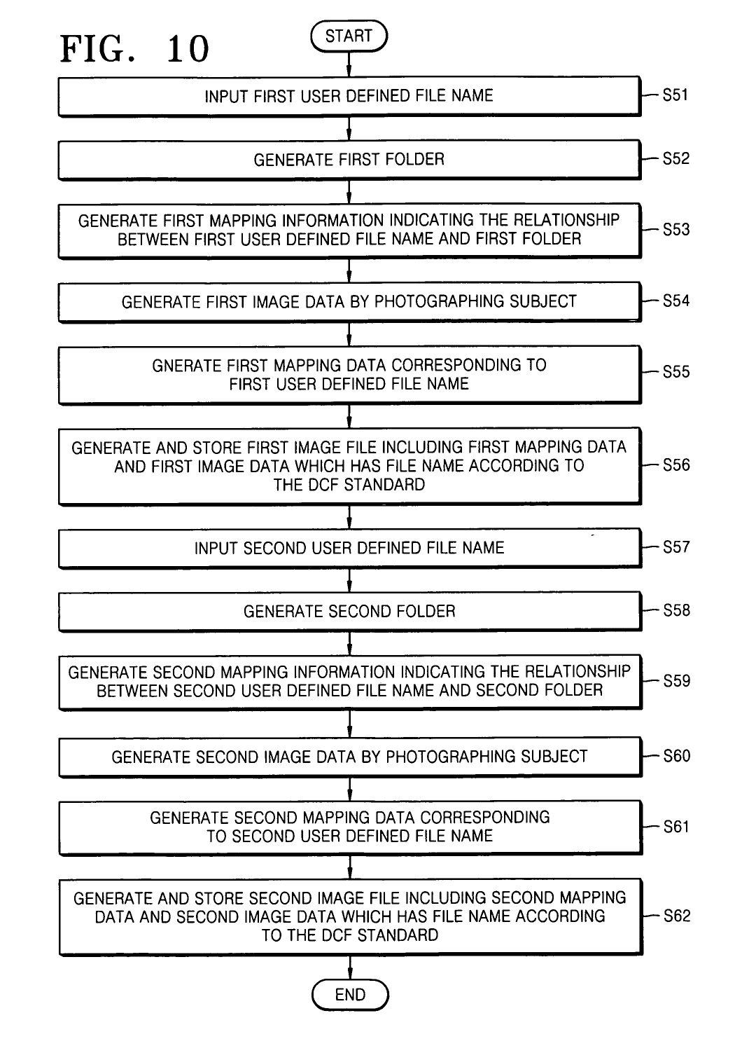

FIG. 10 is a flowchart illustrating a method of controlling a digital photographing apparatus, according to another embodiment of the present invention, the method including inputting a plurality of user defined file names, generating a plurality of folders, and generating a plurality of image files. That is, in the current embodiment of the present invention, the method includes generating a plurality of folders, a plurality of user defined file names, and a plurality of image files.

Referring to FIG. 10, a first user defined file name is firstly input in operation 51. For example, “one-year old birthday party” may be input as the first user defined file name. Then, a first folder Sv1 is generated in operation 52 such that the first folder Sv1 is generated in an auxiliary memory unit.

A first mapping information, “1. one-year old birthday party=Sv1”, indicating the relationship between the first user defined file name, “one-year old birthday party”, and the first folder Sv1 is generated in operation 53. The first mapping information may be recorded to an information memory unit, which is an internal memory unit of a main memory unit of the digital photographing apparatus. Then, a subject is photographed and a first image data is generated in operation 54. A first mapping data corresponding to the first user defined file name is generated in operation 55. The first mapping data indicates the first mapping information and may be formed as, for example, “FN=1”.

A first image file including the first image data and the first mapping data including a file name according to the DCF standard is generated, and the first image file is stored in the first folder, in operation 56. Then, a second user defined file name that is different from the first user defined file name, for example, “wedding ceremony”, is input, in operation 57.

A second folder Sv2 is generated in operation 58 such that the second folder, “Sv2”, is generated in an auxiliary memory unit. A second mapping information, “2.wedding ceremony=Sv2”, indicating the relationship between the second user defined file name, “wedding ceremony”, and the second folder Sv2 is generated in operation 59. The second mapping information may be recorded to an information memory unit, which is an internal memory of the main memory of the digital photographing apparatus. Then, a subject is photographed and a second image data is generated in operation 60.

A second mapping data corresponding to the second user defined file name is generated in operation 61. The second mapping data indicates the second mapping information and may be simply set as, for example, “FN=2”.

A second image file including the generated second mapping information and the second image data is generated and stored in operation 62. Here, the file name of the second image file stored in the digital photographing apparatus is determined according to the DCF standard in order to recognize the image file in the digital photographing apparatus.

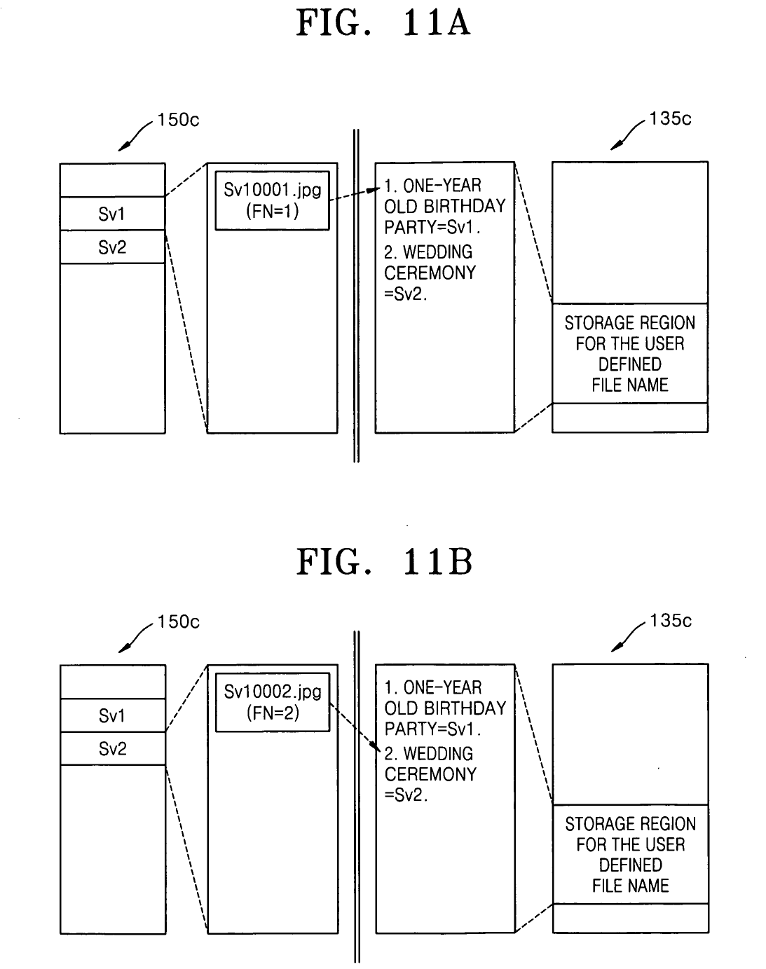

An example of storing the first image file and the second image file to the auxiliary memory unit and an example of storing the mapping information to the information memory unit are illustrated respectively with reference to FIGS. 11A and 11B.

In FIG. 11A, the first and second folders Sv1 and Sv2 are recorded to an auxiliary memory unit 150c of the digital photographing apparatus 100 illustrated in FIG. 1 and the first image file having a file name of “Sv10001.jpg” is stored in the first folder Sv1, such that the file name of “Sv10001.jpg” is determined according to the DCF standard, and the first image file includes the first mapping data, “FN=1”.

The first mapping data indicates the first mapping information, “1. one-year old birthday party=Sv1”, stored in the information memory unit 135 of the digital photographing apparatus 100 illustrated in FIG. 1.

The first mapping information, “1. one-year old birthday party=Sv1”, is stored in a storage region, for the user defined file name, of partitioned blocks in the information memory unit 135c.

In FIG. 11B, the second image file having a file name of “Sv10002.jpg” is stored in the second folder Sv2. The second image file includes the second mapping data, “FN=2”, and the second mapping data indicates the second mapping information, “2.wedding ceremony=Sv2”, stored in a second storage region, for the user defined file name, of the information memory unit 135c.

Accordingly, the user defined file name included in the mapping information may be read by using the mapping data of the image files, and the file name according to the DCF standard may be changed to the user defined file name, thereby displaying the user defined file name.

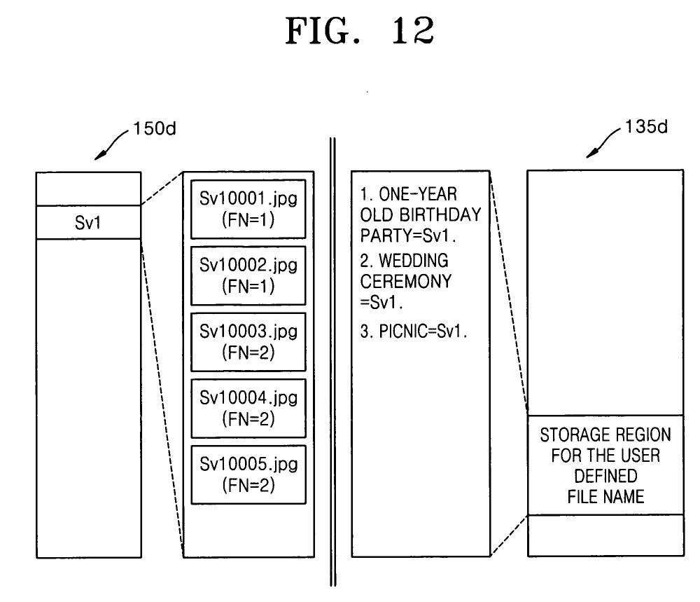

FIG. 12 is a diagram illustrating changing of a user defined file name of an image file as performed in a method of controlling a digital photographing apparatus, according to an embodiment of the present invention. In the current embodiment, the changing of the user defined file name in a playback mode is explained as illustrated in FIG. 12.

Referring to FIG. 12, the folder Sv1 is generated in an auxiliary memory unit 150d of the digital photographing apparatus 100 illustrated in FIG. 1 and five image files are recorded to the folder Sv1. Thus, first to fifth image files are respectively represented with file names according to the DCF standard and include mapping data.

First, two mapping information are stored in the storage region, for the user defined file name, of an information memory unit 135d, such that the mapping information firstly recorded is “1 one-year old birthday party=Sv1” and “2.wedding ceremony=Sv2.”

Here, when the user defined file name is to be changed in the playback mode or in the displaying of the file names of the stored image files, an image file of which the user defined file name is to be changed is selected. In the current embodiment, the third image file, “Sv10003.jpg”, is selected.

Then, a user defined file name is input to change the user defined file name that is to be changed. In current embodiment, “picnic” is the input user defined file name. Thus, mapping information, “3.picnic=Sv1”, indicating the relationship between the input user defined file name and the folder is generated and stored.

Then, mapping data of the selected third image file, “Sv10003.jpg”, is changed to “FN=3.” Here, the user defined file name may be input prior to selecting the image file of which the user defined file name is to be changed.

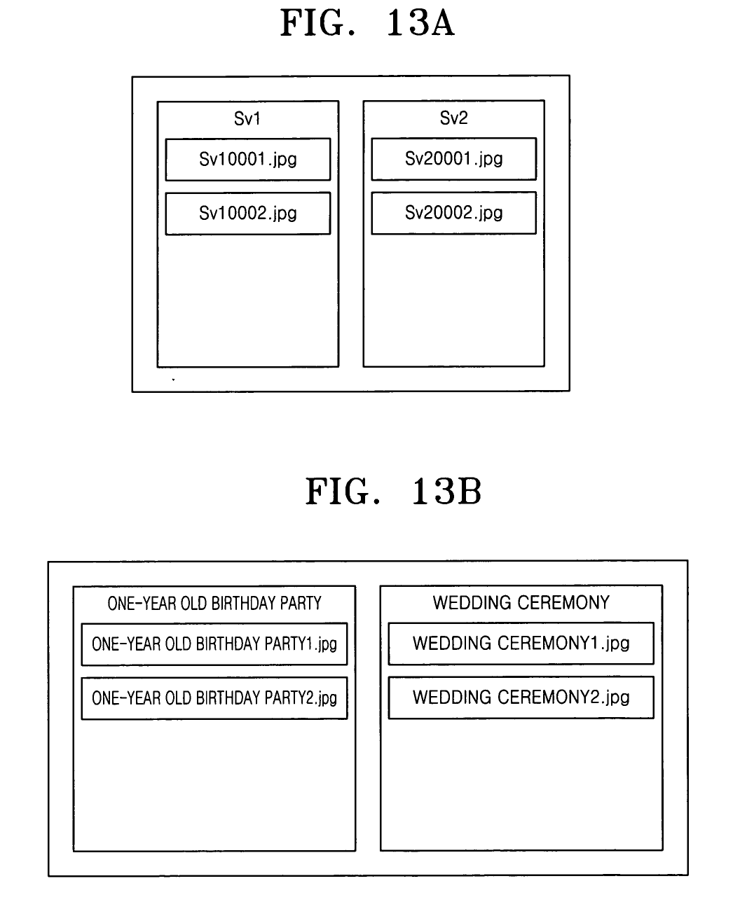

FIGS. 13A and 13B are diagrams illustrating file names displayed on the display unit 140 of the digital photographing apparatus 100, according to an embodiment of the present invention, or on an external device in the case when the external device is connected to the digital photographing apparatus 100, in a method of controlling the digital photographing apparatus 100 according to an embodiment of the present invention.

When the digital photographing apparatus 100 of FIG. 1 is not connected to an external device, for example, a PC or a printer, through the communication unit 180, the display unit 140 of the digital photographing apparatus 100 may display the folders and the file names according to the DCF standard, as illustrated in FIG. 13A.

In addition, when the digital photographing apparatus 100 of FIG. 1 is connected to an external device through the communication unit 180, the user defined file names may be displayed on a display unit of the external device. For example, when two user defined file names “one-year old birthday party” and “wedding ceremony” are input, the folders respectively corresponding to the two user defined file names are generated, and the image files including mapping data respectively corresponding to the two user defined file names or the file names of the image files are displayed. Thus, the folder names may be the input user defined file names as illustrated in FIG. 13B.

The user defined file names are input and stored and mapping data corresponding to the user defined file names is included in image files so that the user defined file name can be read using the mapping data and may be displayed on the display unit of the digital photographing apparatus.

In addition, the user defined file names are input, the folders corresponding to the input user defined file names are generated, mapping information indicating the relationship between the folders and the user defined file names is generated, and image files including mapping data indicating the mapping information are generated. Thus, the user defined file names can be read from the mapping information using the mapping data.

Moreover, the image files are stored in the folders and the image files have the same mapping data. Thus, even if the file names of the image files are not changed, the file names of the image files stored in the folder can be managed.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware components configured to perform the specified functions. The particular implementations shown and described herein are illustrative examples of the invention and are not intended to otherwise limit the scope of the invention in any way. For the sake of brevity, conventional electronics and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. The word mechanism is intended to be used generally and is not limited solely to mechanical embodiments. Numerous modifications and adaptations will be readily apparent to those skilled in this art without departing from the spirit and scope of the present invention.

What is claimed is:

1. A method of controlling a digital photographing apparatus, comprising:
inputting a first user-defined file name;
photographing a subject and generating a first image data;
generating a first mapping data corresponding to the first user defined file name; and
generating a first image file including the first mapping data and the first image data, wherein the first image file has a file name according to a Design rule for Camera File (DCF) standard.

2. The method of claim 1, further comprising:
inputting a second user defined file name;
photographing a subject and generating a second image data;
generating a second mapping data corresponding to the second user defined file name; and
generating a second image file including the second mapping data and the second image data, wherein the second image file has a file name according to the DCF standard.

3. The method of claim 1, further comprising:
selecting the first image file;
reading the first user defined file name according to the first mapping data; and
displaying the first user defined file name.

4. The method of claim 3, wherein displaying the first user defined file name further comprises displaying the first image data with the first user defined file name.

5. The method of claim 3, further comprising:
when the digital photographing apparatus is connected to the external device, displaying the first user defined file name on a display unit of an external device; and
when the digital photographing apparatus is not connected to the external device,
displaying a file name according to the DCF standard is displayed on a display unit of an external device.

6. The method of claim 1, further comprising:
generating a first folder; and
generating first mapping information indicating a relationship between the first user defined file name and the first folder.

7. The method of claim 6, further comprising storing the first image file to the first folder.

8. The method of claim 6, further comprising:
photographing a subject and generating second image data; and
generating a second image file including the first mapping data and the second image data, wherein the second image file has a file name according to the DCF standard.

9. The method of claim 6, further comprising:
inputting a second user defined file name;
generating second mapping information indicating a relationship between the second user defined file name and the first folder;
photographing a subject and generating the second image data;
generating the second mapping data corresponding to the second user defined file name; and
generating a second image file including the second mapping data and the second image data, wherein the second image file has a file name according to the DCF standard.

10. The method of claim 6, further comprising:
inputting a second user defined file name;
generating a second folder;
generating second mapping information indicating a relationship between the second user defined file name and the second folder;
photographing a subject and generating second image data;
generating second mapping data corresponding to the second user defined file name; and
generating a second image file including the second mapping data and the second image data, wherein the second image file has a file name according to the DCF standard.

11. A digital photographing apparatus comprising:
an operation unit having an input element for inputting a user defined file name;
an imaging unit to photograph a subject and generate image data;
a mapping data generation unit which generates mapping data corresponding to the user defined file name; and
a memory unit including the mapping data and the image data so as to generate an image file having a file name according to the DCF standard.

12. The apparatus of claim 11, wherein the memory unit stores the user defined file name.

13. The apparatus of claim 11, further comprising:
a folder generation unit which generates a folder; and
a mapping information generation unit which generates mapping information indicating the relationship between the folder and the user defined file name,
wherein the memory unit stores the folder and the mapping information.

14. The apparatus of claim 11, further comprising an auxiliary memory unit which stores the image file.

15. The apparatus of claim 11, further comprising a display unit which displays the user defined file name read from the mapping data.

16. The apparatus of claim 11, further comprising:
a communication unit which is connectable to an external device; and
a connection sensing unit which determines whether the external device is connected to the communication unit,
wherein when the external device is connected to the communication unit as based on the determination result of the connection sensing unit, the user defined file name is displayed on a display unit of the external device, and when the external device is not connected to the communication unit, a file name according to the DCF standard is displayed on the display unit of the digital photographing apparatus.
